(19) United States
(12) Patent Application Publication
(10) Pub. No.: US 2012/0254028 A1
(43) Pub. Date: Oct. 4, 2012

(54) APPARATUS AND METHOD FOR ISSUING TRANSACTION CARDS

(75) Inventor: Thomas Elgar, London (GB)

(73) Assignee: SERVERSIDE GROUP LIMITED, London (GB)

(21) Appl. No.: 13/386,383

(22) PCT Filed: Jul. 22, 2010
(86) PCT No.: PCT/GB2010/051211

§ 371 Date: Jun. 1, 2012

(30) Foreign Application Priority Data
Jul. 22, 2009 (GB) 0912734.1
Jan. 11, 2010 (GB) 1000353.1
Mar. 10, 2010 (GB) 1003963.4

(51) Int. Cl. G06K 15/02; G06Q 20/34; G06Q 40/00

(52) U.S. Cl. 705/41; 358/1.15; 358/1.14

(57) ABSTRACT

A transaction card production apparatus for producing transaction cards comprising user card designs, the apparatus comprising: a processor module configured to receive a user card number and a user card design from a user, associate the user card number with the user card design and store the user card number and associated user card design in a storage module; a card issuer module configured to receive the user card number from the processor module and generate a user embossing record comprising the user card number; and a card production bureau configured to receive the user embossing record from the card issuer module, retrieve the user card design associated with the user card number from the storage module and print a transaction card comprising the user card number and user card design.

### TECHNICAL FIELD

The invention relates to apparatus and methods for issuing transaction cards. In particular, the inventions relates to apparatus and methods for issuing transaction cards comprising images.

### BACKGROUND

Known systems for applying an image to a transaction card require the addition of an image identifier (IMAGEID), related to the image, to the transaction card issuers mainframes and to the embossing record which is transferred from the card issuers mainframes to card bureaus for printing the cards. The IMAGEID allows the matching of an image to be printed on a card to the correct financial data of the user which is to be embossed on the card, encoded in the magnetic stripe and/or encoded in the chip on the card.

However, since the card issuers are required to change their IT systems to incorporate the IMAGEID, these systems are not considered favourably by the card issuers.

The invention provides apparatus and methods for applying an image to a transaction card which do not require card issuers to change their IT systems.

### SUMMARY

According to one embodiment of the invention a transaction card production apparatus for producing transaction cards comprising user card designs is provided. The apparatus comprises: a processor module configured to receive a user card number and a user card design from a user, associate the user card number with the user card design and store the user card number and associated user card design in a storage module; a card issuer module configured to receive the user card number from the processor module and generate a user embossing record comprising the user card number; and a card production bureau configured to receive the user embossing record from the card issuer module, retrieve the user card design associated with the user card number from the storage module and print a transaction card comprising the user card number and user card design.

According to another embodiment of the invention the processor module is further configured to receive user identification data from the user, and the apparatus further comprises: a card verification module configured to verify the user card number using the user identification data.

According to another embodiment of the invention the user identification data comprises a user password.

According to another embodiment of the invention the card verification module comprises a database storing user card numbers associated with user identification data.

According to another embodiment of the invention if the user card number is not verified by the card verification module, then the user card number is not associated with the user card design.

According to another embodiment of the invention the card issuer module is further configured to generate a replacement user card number, and transfer the user card number and the replacement user card number to the card verification module, and wherein the card verification module is further configured to associate the replacement user card number with the user identification data.

According to another embodiment of the invention the card issuer module is further configured to generate a replacement user card number and transfer the replacement user card number to the processor module, and wherein the processor module is further configured to replace the user card number with the replacement user card number in the storage module, such that the replacement user card number is associated with the user card design.

According to another embodiment of the invention the card issuer module is further configured to generate a replacement user card number and transfer the replacement user card number to the processor module, and wherein the processor module is further configured to associate the replacement user card number with the user card design in the storage module.

According to another embodiment of the invention the card issuer module is further configured to transfer the user card number and the replacement user card number to the processor module.

According to another embodiment of the invention the storage module is provided at the processor module.

According to another embodiment of the invention the apparatus further comprises: a second storage module provided at the card production bureau, and wherein the user card number and associated user card design are transferred to the second storage module.

According to another embodiment of the invention the storage module is provided at the card production bureau.

According to another embodiment of the invention the apparatus further comprises: a card designer module configured to enable a user to create the user card design.

According to another embodiment of the invention the apparatus further comprises: a card designer module configured to enable a user to select the user card design from a plurality of card designs held at the card designer module.

According to another embodiment of the invention the card issuer module is further configured to receive a request for a new card comprising the user card number and user card design from the processor module.

According to another embodiment of the invention the card production bureau is further configured to receive a request to print a new card comprising the user card number and user card design together with the user embossing record from the card issuer module.

According to another embodiment of the invention the embossing record comprises a marker indicating that there is a user card design associated with the user card number.

According to another embodiment of the invention the user card number comprises a card number of a card to which the user card design is to be applied.

According to another embodiment of the invention the transaction card comprises any one of: a credit card; a debit card; a gift card; a loyalty card; a store card; a telephone card.

According to another embodiment of the invention the apparatus further comprises a payment module configured to receive the user card number and a temporary user card design identifier from the processor module and to receive a payment from the user's card associated with the user card number.

According to another embodiment of the invention following receipt of the payment, the user card number and the temporary user card design identifier are transferred from the payment module to the processor module and the temporary user card design identifier is deleted.

According to another embodiment of the invention the payment module is configured to validate the user without receiving a payment from the user's card.

According to one embodiment, the invention provides a method for producing transaction cards comprising a user card design is provided. The method comprising: receiving at a processor module a user card number and a user card design from a user, associating the user card number with the user card design and storing the user card number and associated user card design in a storage module; receiving at a card issuer module the user card number from the processor module, and generating a user embossing record comprising the user card number; and receiving at a card production bureau the user embossing record from the card issuer module, retrieving the user card design associated with the user card number from the storage module, and printing a transaction card comprising the user card number and user card design.

According to another embodiment of the invention the method further comprises: receiving at the processor module user identification data from the user; and verifying at a card verification module the user card number using the user identification data.

According to another embodiment of the invention the method further comprises: not associating the user card number with the user card design if the user card number is not verified by the card verification module.

According to another embodiment of the invention the method further comprises: generating at the card issuer module a replacement user card number; and receiving at the card verification module the user card number and the replacement user card number, and associating the replacement user card number with the user identification data.

According to another embodiment of the invention the method further comprises: generating at the card issuer module a replacement user card number; and receiving at the processor module the replacement user card number, and replacing the user card number with the replacement user card number in the storage module, such that the replacement user card number is associated with the user card design.

According to another embodiment of the invention the method further comprises: generating at the card issuer module a replacement user card number; and receiving at the processor module the replacement user card number, and associating the replacement user card number with the user card design in the storage module.

According to another embodiment of the invention the method further comprises: receiving at the processor module the user card number and the replacement user card number.

According to another embodiment of the invention the method further comprises: transferring the user card number and associated user card design to a second storage module at the card production bureau.

According to another embodiment of the invention the method further comprises: creating at a card designer module the user card design.

According to another embodiment of the invention the method further comprises: selecting at a card designer module the user card design from a plurality of card designs held at a card designer module.

According to another embodiment of the invention the method further comprises: receiving at the card issuer module a request for a new card comprising the user card number and user card design from the processor module.

According to another embodiment of the invention the method further comprises: receiving at the card production bureau a request to print a new card comprising the user card number and user card design together with the user embossing record from the card issuer module.

According to another embodiment of the invention the method further comprises: receiving at a payment module the user card number and a temporary user card design identifier from the processor module; and receiving a payment from the user's card associated with the user card number.

According to another embodiment of the invention the method further comprises: transferring the user card number and the temporary user card design identifier from the payment module to the processor module following receipt of the payment; and deleting the temporary user card design identifier.

According to another embodiment of the invention the method further comprises: validating the user without receiving a payment from the user's card.

According to one embodiment, the invention provides an article of manufacture comprising: a machine readable storage medium; and executable program instructions embodied in the machine readable storage medium that when executed by a programmable system cause the system to produce transaction cards comprising a user card design is provided, the system performing functions comprising: receiving at a processor module a user card number and a user card design from a user, associating the user card number with the user card design and storing the user card number and associated user card design in a storage module; receiving at a card issuer module the user card number from the processor module, generating a user embossing record comprising the user card number; and receiving at a card production bureau the user embossing record from the card issuer module, retrieving the user card design associated with the user card number from the storage module, and printing a transaction card comprising the user card number and user card design.

According to one embodiment, the invention provides a computer program product comprising programme code means for performing the methods described above is provided.

According to one embodiment, the invention provides a computer readable medium recorded with computer readable code arranged to cause a computer to perform the methods described above is provided.

According to one embodiment of the invention a computer programme code means for performing the methods described above is provided.

Additional advantages and novel features of the invention will be set forth in part in the description which follows, and in part will become apparent to those skilled in the art upon examination of the following and accompanying figures or may be learned by practice of the invention.

### BRIEF DESCRIPTION OF THE FIGURES

For a better understanding of the invention and to show how the same may be carried into effect reference will now be made, by way of example only, to the accompanying figures, in which:

FIG. 1 illustrates schematically an overview of a process for creating and issuing a transaction card;

FIG. 2A illustrates schematically a process for creating and issuing a transaction card comprising a user design;

FIG. 2B illustrates schematically another process for creating and issuing a transaction card comprising a user design; and

FIG. 3 illustrates schematically apparatus for performing the processes of FIGS. 2A and 2B.

### DETAILED DESCRIPTION

Reference will now be made in detail to the embodiments of the invention, examples of which are illustrated in the accompanying figures. In the following detailed description, numerous specific details are set forth in order to provide a thorough understanding of the invention. However, it will be apparent to one of ordinary skill in the art that the invention may be practiced without these specific details.

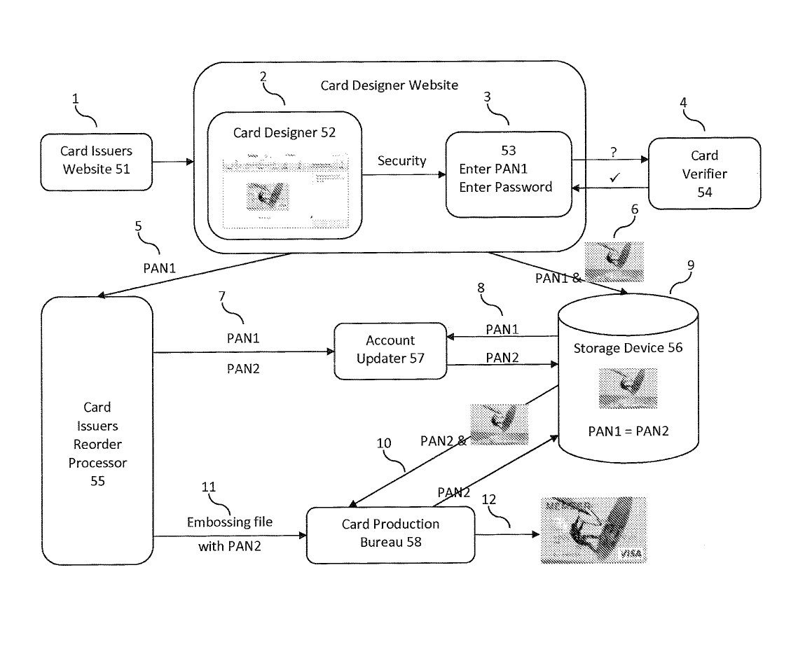

FIG. 1 illustrates an overview of one process for creating and issuing a transaction card comprising a card design, e.g. a process of applying a customised image to a payment card which is largely external to card issuers. A transaction card may be considered to be any type of financial account access means such as a credit card, a debit card etc. In addition a transaction card may be considered a gift card, a loyalty card, a store card, a telephone card etc.

At step 1 a user enters a card issuer's website 51 and selects to design their own card. This may alternatively be done using another initiating websites. The user is transferred to a card designer 52, which may be a card design interface, at step 2 so that they can design their own card. Designing their own card may involve a card design image being created at this point, or may involve producing data relating to a card design image to be created later. The card design is associated with the website user. In one embodiment, the card design is stored and correctly associated with the user using a short-term card image ID. No data is required to be passed to the card designer 52 other than a standard URL.

Following completion of their card design, the user is required to enter the primary account number (PAN1) of a card (the user's card) to which their card design is to be applied. In one embodiment, the user already has a transaction card obtained from a financial institution in relation to an existing account. As is known in the art, transaction cards are provided with a card number, normally a sixteen digit number on the front of the card. It is this card number together with a password associated with the PAN1 that the user enters at step 3, ideally in a secure environment.

In another embodiment, the user may have been issued a card number in relation to an existing account, for example provided by a secure letter to the user, for use with the system of the present application. In this embodiment, the user enters the issued card number at step 3.

The user's identity may then be verified at step 4 by a card verifier 54. The card verifier may for example be a third party password service. If the user's identity is to be verified by password, when a user entered password and PAN1 are matched together the user's identity is accepted as verified. If the password and PAN1 do not match then the user will need to re-enter the PAN number and password. Once the user's identity has been verified at step 4 the card design is associated with the PAN1, and the card design, or card image, and the PAN1 are transferred to and stored in a storage device 56 at step 6. Preferably, once the card image and the PAN1 are matched together, the image and PAN1 ID are passed through the standard image checking processes (i.e. the image is checked for obscenity, copyright etc) and held for use later. In addition, the PAN1 is transferred to a card issuers reorder processor 55 at step 5.

The card issuers reorder processor 55 is a system for issuing and reissuing transaction cards as required. The card issuers reorder processor 55 may be provided at a transaction card issuer and has access to the user's financial data associated with the PAN1 existing account. The card issuers reorder processor 55 is therefore able to generate embossing records as known in the art.

Optionally, once the user's identity is verified the PAN1 is passed to the card issuers reorder processor 55 at step 5, and a call is made to the card issuer through their existing card reissue process or lost and stolen card process. A new PAN (PAN2) will typically be generated, though this is not essential. A new card is then ordered in the same way as would occur by the reissue or lost and stolen processes. This is not the only way to create a new card but it utilises an existing process and therefore very little impact on the IT systems of the card issuer is expected.

In the illustrated embodiment, a new primary account number (PAN2) is generated and transferred together with PAN1 to an account updater 57 for updating the card verifier at step 7. For example, using another third party tool, at step 7, the card issuers update an external database (for example Visa's Account Updater) with the new PAN2 (if required). If the card user has issued a new PAN, PAN2 is also transferred to the storage device 56 at step 8 where the Account Updater can be polled to match PAN1 against the new PAN (PAN 2), and associated with the card design in the storage device 56 at step 9; e.g. the card image may be updated to be referenced by the new ID (PAN2). In one embodiment the PAN1 reference is also retained for audit purposes.

An embossing record for PAN2 is transferred to the card production bureau 58 at step 11. The card production bureau 58 transfers the PAN2 of the embossing record to the storage device 156 and retrieves the associated card design at step 10. Steps 10 and 11 do not need to be performed in any specific order. Finally a new card is printed with the card design and the PAN2 at step 12. As explained above, issue of a new PAN 2 is preferred, but not essential.

Although FIG. 1 illustrates a user entering a card issuer's website 51 and then being transferred to a card designer 52, the user may go directly to the card designer website.

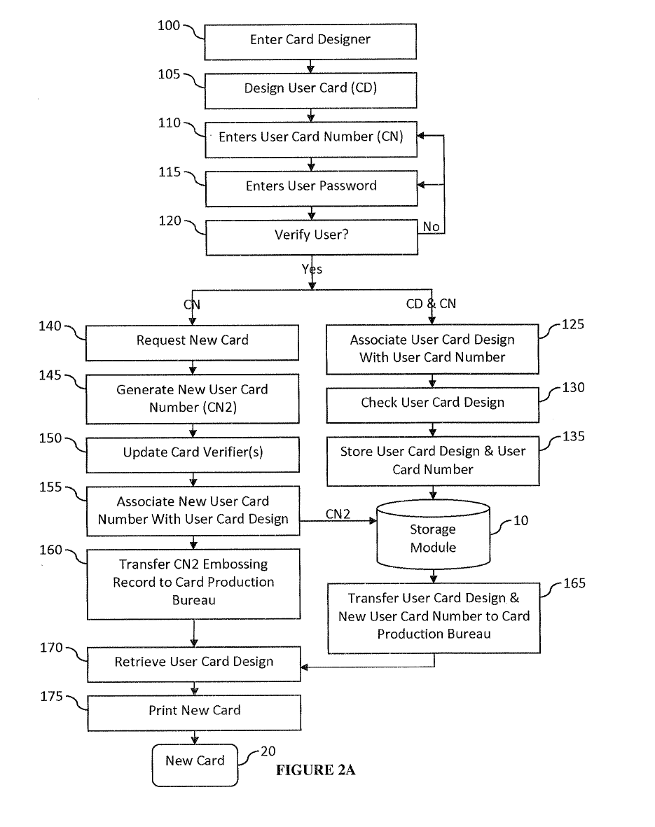

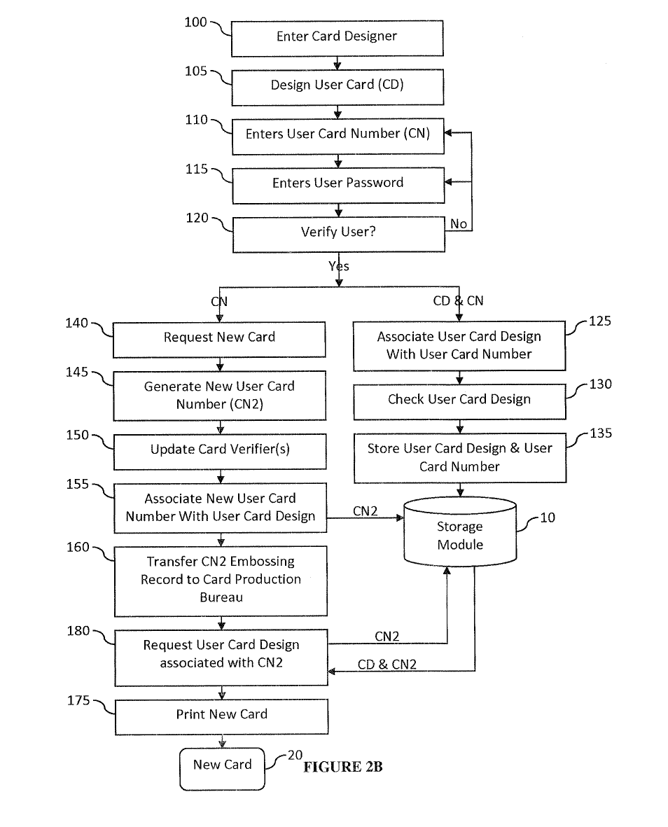

FIGS. 2A and 2B illustrate the process of FIG. 1 in further detail.

FIG. 2A illustrates schematically a method for creating and issuing a transaction card comprising a user design. At step 100 a user enters a card designer and designs a user card design (CD) at step 105. The card designer may be any known card designer such as that disclosed in International Patent Publication No. 04074961 incorporated herein by reference. In one embodiment, the card design may be associated with the user via a short-term card design identifier, such that the design can be temporarily stored and associated with the user at the card designer.

Following creation of the card design the user is required to enter the card number (CN) of the card to which the card design is to be applied at step 110. The card number may be a primary account number (PAN) which is present on virtually all transaction cards. The user may also be required to enter user verification data, such as a password at step 115. However other user verifying data may be required instead of or in addition to a password at step 115 such as the user's date of birth and/or the user's mother's maiden name etc. Steps 110 and 115 may be combined. The user's identity may then be verified at step 120 by a card verifier. The card verifier, or password store, may be a known third party service, such as Verified by Visa™ which is utilised for online shopping, or other verification systems (such as MasterCard SecureCode™ or 3D Secure) may be used in order to confirm that the user is in fact the owner of the account for which the primary account number has been supplied and/or is authorised to order a card comprising the card number and the new card design. If the user's identity is not verified at step 120, then the user may be required to enter the card number and/or password (verification data) again at steps 110 and 115. As known in the art after several failed attempts at verification the user may be barred from re-attempting to verify the card number.

Ideally, the verification process takes place in a secure environment, therefore, the user may be transferred to the card verifier before being required to enter their card number and/or verification data. A card verifier may be a password store held by a third party. The store is a database that holds a list of card numbers and a list of related user verification data, and so can verify that the user is authorised to change the design on the card since the user has access to the card number and the verification data.

In one embodiment, if the user is required to pay a fee for having a card design on their transaction card, then the capture of the card number may be achieved using an electronic payment solution such as Barclaycard ePDQ™ or RBS WorldPay™. In this embodiment, where the user is required to pay a fee for having a card design on their transaction card, a temporary card design identifier may be passed with the user to an electronic payment solution interface. The card number is captured as part of the payment process, verified and passed back to the card designer together with the temporary card design identifier so that the card number can be associated with the card design. The temporary card design identifier is then no longer required.

It is possible in this embodiment that the PAN of different cards can be captured—one for the payment for the personalization service and one for the PAN of the card to be personalized.

In one embodiment, a payment process such as the known Cardholder Not Present (CNP) transaction process, may be used when the card holder is not present at the site where the transaction is taking place. In one embodiment, the CNP transaction process includes one of the known verification systems in order to authenticate the cardholder (user). The CNP transaction process requires the user to provide the card number (PAN) and one or more of: the expiry date of the card; the Card Verification Code (CVV), which in most instances is provided on the reverse of the card; the user password for the utilised verification system; the user's post code if an Address Verification Service (AVS) is being utilised etc. The CNP transaction process may also include a registration step if the cardholder is not already registered with a verification system. As with the above embodiment, a temporary card design identifier may be passed with the user to the CNP transaction process. Following completion of the transaction process (in order to obtain payment from the user and verify the user), the card number is passed back to the card designer together with the temporary card design identifier so that the card number can be associated with the card design. The temporary card design identifier is then no longer required.

In another embodiment the ‘Cardholder Not Present’ transaction process does not include a verification system.

In another embodiment, the ‘Cardholder Not Present’ transaction process may be utilised when the user is not required to pay for having a card design on their transaction card. In this embodiment, the CNP transaction process requires the user to provide the card number (PAN) and the CVV data. The input of the PAN and CVV data by the user enables the CNP transaction process to authorise the user and authorises a nominal amount to be charged to the user. However this nominal amount is never settled with the bank (as a result of it being for a nominal amount). Thus the known CNP transaction process may be utilised to validate the user without requiring the user to be registered with a verification system and without requiring the user to make a payment.

In another embodiment, the user may use one card number for payment and may also enter another card number of the card to be personalized with the card design. This arrangement may be advantageous if the user is purchasing a gift card or telephone card etc. which is to be provided with credit.

Once the user has been verified at step 120, which can for example be done by a third party password service, the card design is associated with the card number at step 125. In one embodiment, the card design may be subjected to a checking process at step 130 as known in the art for example to ensure that the card design does not infringe any copyright and/or is not offensive etc. The card design and associated card number are then stored in a storage module 10 at step 135. The storage module (as with any part of the system that uses the PAN data) will be held a highly secure environment.

In addition, the card number is transferred to a card issuer together with a request for a new card at step 140. The transfer of the card number alone may be enough to request and instigate the issue of a new card. In one embodiment, a request for a new card is made using the card issuers existing card reissue process or lost and stolen card reissue process. A new card is thus ordered in the same way as if a standard reissue, or lost and stolen process is being used. However, other processes for requesting a new card may be utilised.

A new card number (CN2) is generated at step 145 and then used to update the card verifier 54 at step 150. For example the card number (CN) together with the new card number (CN2) are transferred to the card verifier such that when the new card number is used in future it is associated with the correct user password/user verification data and the new card number can be verified and used for example for online purchases.

The new card number is also associated with the card design in the storage module 10 at step 155. For example the new card number (CN2) together with the original card number (CN) may be transferred to the storage module and then the new card number used to replace the original card number in the storage module. Alternatively, the card number (CN) may be transferred from the storage module to the card verifier or card issuer, and the new card number (CN2) returned, so that the new card number is used to replace the original card number in the storage module. In one embodiment the original card number may also be stored in the storage module together with the new card number and the user card design (CD) for auditing purposes.

In one embodiment a new card number is not required, the original card number is used for the new card. In that instance steps 145 and 150 and 155 are not required, since the details held at the card verifier and storage module do not need to be updated.

An embossing record for the new card number is generated at the card issuer and transferred to the card production bureau at step 160. In addition, the card design together with the new card number (or the original card number if appropriate) are transferred to a card production bureau at step 165. The card design and card number may then be stored in a storage module at the card production bureau, until required. The card production bureau retrieves the user card design (if one is available) associated with the new card number (or the original card number if appropriate) from the storage module, and prints a new card 20 with the new card number (or the original card number if appropriate) and the user card design at step 175.

In another embodiment, illustrated in FIG. 2B in which steps 100 to 160 and 175 are the same as those described above with reference to FIG. 2A, the card production bureau requests the associated user card design (if one is available), based on the new card number (or the original card number if appropriate), from the storage module 10. The card design together with the new card number (or the original card number if appropriate) are transferred to the card production bureau and a new card 20 is printed with the new card number (or the original card number if appropriate) and the user card design at step 175.

In either embodiment, the new card 20 may be sent to the user using known systems.

The card production bureau may retrieve/request the new user card design upon receipt of the new card number (or the original card number) embossing record. Alternatively, the card production bureau may store the received new card number embossing record to create a batch before retrieving a batch of card designs and printing the batch of new cards 20.

In one embodiment, there may be a marker provided in the embossing record indicating that there is a card design associated with the card number. In this embodiment, only the card numbers which have a marker need to be checked against the card numbers passed to the card bureau in step 165 to identify the associated card design in accordance with FIG. 2A. Alternatively, in this embodiment, only the card numbers which have a marker need to be transferred to the storage device 10 to request the associated card design be passed to the card bureau in accordance with FIG. 2B.

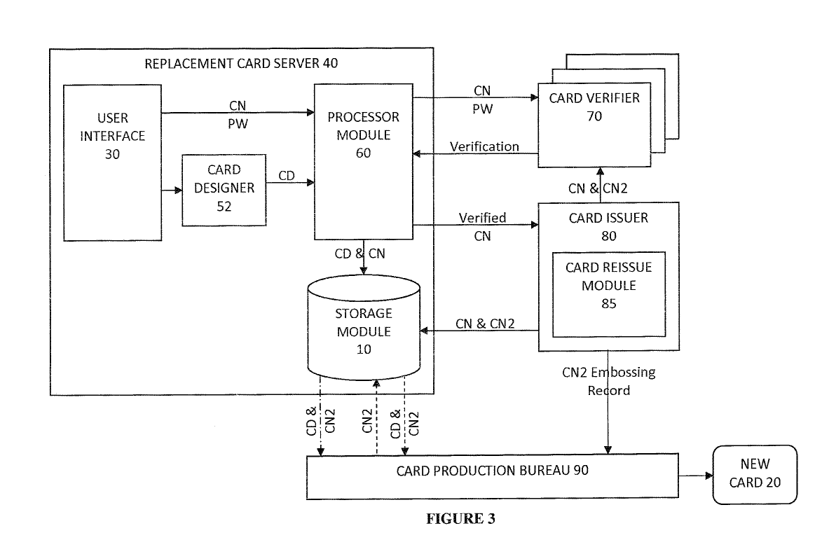

FIG. 3 illustrates schematically apparatus for performing the method of FIGS. 2A and 2B. A replacement card server 40 comprises a user interface 30, a processor module 60, a storage module 10 and a card designer 52. In one embodiment, the card designer 52 may be provided by a third party separate from the replacement card server 40.

When an user enters a website for creating a card design for application to an existing card, the user can create a card design using the card designer 52. Following creation of the card design (CD), the card design is transferred to the processor module 60 at the replacement card server 40. The processor module 60 then requests the user enter a card number for which the new card design is to be applied. In addition the user may be required to enter user verification data, such as a user password (PW) and/or other user verification data. As discussed above, the card number may be obtain using an electronic payment solution.

In one embodiment, the processor module 60 transfers the card number and user verification data to a card verifier 70. Alternatively, the processor module 60 may direct/transfer the user to the card verifier 70 directly, such that the card number and/or user password and/or other user verification data are entered directly by the user into the card verifier 70.

The card verifier 70 may be a third party card verifier and thus is illustrated as separate from the replacement card server 40. However, in another embodiment the card verifier 70 may be provided as part of the replacement card server 40.

Following verification of the card number by the card verifier 70, confirmation of the verification is transferred back to the processor module 60.

The processor module 60 associates the card design with the verified card number and transfers them (CD & CN) to a storage module 10. In addition, the processor module 60 transfers the verified card number to a card issuer 80.

The card issuer 80 may use standard systems for ordering replacement cards and new cards. If required a new card number (CN2) is generated by the card re-issue module 85 of the card issuer 80 and associated with the previous card number (CN). This new card number is then transferred to the storage module 10 for association with the card design (CD). In addition, the new card number is transferred to the card verifier 70 together with the original card number (CN), such that when the new card number is used in future it is associated with the correct user password/user verification data and the new card number can be verified.

A new card number embossing record is transferred to a card production bureau 90 by the card issuer 80 together with a request for a new card. In one embodiment, the transfer of an embossing record alone may be considered a request for a new card. The card design together with the new card number may also transferred to the card production bureau 90 from the storage module 10, in accordance with the method of FIG. 2A and illustrated by the dot dash line in FIG. 3. The received card design and card number may be stored in a storage module (not illustrated) at the card production bureau 90, if required. The card production bureau 90 identifies the associated card design (if available) and prints a new card 20 comprising the card design (CD) and the new card number (CN2).

Alternatively, a request for the card design associated with the new card number may be transferred from the card production bureau 90 to the storage module 10 and the card design is returned (if available) in accordance with the method of FIG. 2B and illustrated by the two dotted lines in FIG. 3. The card production bureau 90 then prints a new card 20 comprising the card design (CD) and the new card number (CN2).

In one embodiment, a new card number is not generated at the card issuer 80. Consequently, the card is printed with the existing card number (CN) and the card design (CD).

The new card 20 is then sent to the user using known systems.

Although the above method and apparatus are described with reference to a user designing their own card design, the method and apparatus described above could also be used when a user selects a card design from a plurality of pre-existing designs. In this embodiment, steps 100 and 105 illustrated in FIGS. 2A and 2B are replaced by a step of selecting one of the plurality of pre-existing designs.

In another embodiment, the user may be required to enter their card number and have it verified before designing a card/selecting one of the plurality of pre-existing designs. In this embodiment, steps 110, 115 and 120 are completed before step 105. Therefore, a user does not waste time designing a card if they are not authorised to order a new card.

The apparatus described may be implemented at least in part in software. Those skilled in the art will appreciate that the apparatus describe above may be implemented using general propose computer equipment or using bespoke equipment.

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Here, aspects of the methods and apparatuses described herein can be executed on a mobile station and on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what is considered to be the best mode and, where appropriate, other modes of performing the invention, the invention should not be limited to the specific configurations and methods disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognise that the invention has a broad range of applications, and that the embodiments may take a wide range of modifications without departing from the inventive concept as defined in the appended claims.

1. A transaction card production apparatus for producing transaction cards comprising user card designs, the apparatus comprising:
a processor module configured to receive a user card number and a user card design from a user, associate the user card number with the user card design and store the user card number and associated user card design in a storage module;
an interface for sending to a card issuer module the user card number from the processor module,
wherein the card issuer module is configured to generate a user embossing record comprising the user card number and send it to a card production bureau configured to receive the user embossing record from the card issuer module, and
wherein the card production bureau is configured to retrieve the user card design associated with the user card number from the storage module and print a transaction
card comprising the user card number and user card design; and
a card verification module configured to verify the user card number using the user identification data wherein the processor module is further configured to receive user identification data from the user.

2. The apparatus of claim 1, wherein the user identification data comprises a user password.

3. The apparatus of claim 1, wherein the card verification module comprises a database storing user card numbers associated with user identification data.

4. The apparatus of claim 1, wherein if the user card number is not verified by the card verification module, then the user card number is not associated with the user card design.

5. The apparatus of claim 1, wherein the card issuer module is further configured to generate a replacement user card number, and transfer the user card number and the replacement user card number to the card verification module, and wherein the card verification module is further configured to associate the replacement user card number with the user identification data.

6. The apparatus of claim 1, wherein the card issuer module is further configured to generate a replacement user card number and transfer the replacement user card number to the processor module, and wherein the processor module is further configured to replace the user card number with the replacement user card number in the storage module, such that the replacement user card number is associated with the user card design.

7. The apparatus of claim 1, wherein the card issuer module is further configured to generate a replacement user card number and transfer the replacement user card number to the processor module, and wherein the processor module is further configured to associate the replacement user card number with the user card design in the storage module.

8. The apparatus of claim 6, wherein the card issuer module is further configured to transfer the user card number and the replacement user card number to the processor module.

9. The apparatus of claim 1, wherein the storage module is provided at the processor module.

10. The apparatus of claim 9, further comprising:
a second storage module provided at the card production bureau, and wherein the user card number and associated user card design are transferred to the second storage module.

11. The apparatus of claim 1, wherein the storage module is provided at the card production bureau.

12. The apparatus of claim 1, further comprising:
a card designer module configured to enable a user to create the user card design.

13. The apparatus of claim 1, further comprising:
a card designer module configured to enable a user to select the user card design from a plurality of card designs held at the card designer module.

14. The apparatus of claim 1, wherein the card issuer module is further configured to receive a request for a new card comprising the user card number and user card design from the processor module.

15. The apparatus of claim 1, wherein the card production bureau is further configured to receive a request to print a new card comprising the user card number and user card design together with the user embossing record from the card issuer module.

16. The apparatus of claim 1, wherein the embossing record comprises a marker indicating that a user card design is associated with the user card number.

17. The apparatus of claim 1, wherein the user card number comprises a card number of a card to which the user card design is to be applied.

18. The apparatus of claim 1, wherein the transaction card comprises any one of: a credit card; a debit card; a gift card; a loyalty card; a store card; a telephone card.

19. The apparatus of claim 1, further comprising:
a payment module configured to receive the user card number and a temporary user card design identifier from the processor module and to receive a payment from the user's card associated with the user card number.

20. The apparatus of claim 19, wherein following receipt of the payment, the user card number and the temporary user card design identifier are transferred from the payment module to the processor module and the temporary user card design identifier is deleted.

21. The apparatus of claim 19, wherein the payment module is configured to validate the user without receiving a payment from the user's card.

22. A method for producing transaction cards comprising a user card design, the method comprising:
receiving at a processor module a user card number and a user card design from a user, associating the user card number with the user card design and storing the user card number and associated user card design in a storage module;
sending to a card issuer module the user card number from the processor module,
generating a user embossing record comprising the user card number at the card issuer module and sending to a card production bureau a card production bureau the user embossing record from the card issuer module,
retrieving the user card design associated with the user card number from the storage module, and printing a transaction card comprising the user card number and user card design;
receiving at the processor module user identification data from the user; and
verifying at a card verification module the user card number using the user identification data.

23. The method of claim 22, further comprising:
not associating the user card number with the user card design if the user card number is not verified by the card verification module.

24. The method of claim 22, further comprising:
generating at the card issuer module a replacement user card number; and
receiving at the card verification module the user card number and the replacement user card number, and associating the replacement user card number with the user identification data.

25. The method of claim 22, further comprising:
generating at the card issuer module a replacement user card number; and
receiving at the processor module the replacement user card number, and replacing the user card number with the replacement user card number in the storage module, such that the replacement user card number is associated with the user card design.

26. The method of claim 22, further comprising:
generating at the card issuer module a replacement user card number; and
receiving at the processor module the replacement user card number, and associating the replacement user card number with the user card design in the storage module.

27. The method of claim 25, further comprising:
receiving at the processor module the user card number and the replacement user card number.

28. The method of claim 22, further comprising:
transferring the user card number and associated user card design to a second storage module at the card production bureau.

29. The method of claim 22, further comprising:
creating at a card designer module the user card design.

30. The method of claim 22, further comprising:
selecting at a card designer module the user card design from a plurality of card designs held at a card designer module.

31. The method of claim 22, further comprising:
receiving at the card issuer module a request for a new card comprising the user card number and user card design from the processor module.

32. The method of claim 22, further comprising:
receiving at the card production bureau a request to print a new card comprising the user card number and user card design together with the user embossing record from the card issuer module.

33. The method of claim 22, further comprising:
receiving at a payment module the user card number and a temporary user card design identifier from the processor module; and
receiving a payment from the user's card associated with the user card number.

34. The method of claim 33, further comprising:
transferring the user card number and the temporary user card design identifier from the payment module to the processor module following receipt of the payment; and
deleting the temporary user card design identifier.

35. The method of claim 33, further comprising:
validating the user without receiving a payment from the user's card.

36. An article of manufacture comprising:
a machine readable storage medium; and
executable program instructions embodied in the machine readable storage medium that when executed by a programmable system cause the system to produce transaction cards comprising a user card design, the system performing functions comprising:
receiving at a processor module a user card number and a user card design from a user, associating the user card number with the user card design and storing the user card number and associated user card design in a storage module;
receiving at a card issuer module the user card number from the processor module, generating a user embossing record comprising the user card number; and
receiving at a card production bureau the user embossing record from the card issuer module, retrieving the user card design associated with the user card number from the storage module, and printing a transaction card comprising the user card number and user card design.

37. (canceled)

38. (canceled)

39. (canceled)

40. The apparatus of claim 7, wherein the card issuer module is further configured to transfer the user card number and the replacement user card number to the processor module.

41. The method of claim 26, further comprising:
receiving at the processor module the user card number and the replacement user card number.
